(19) United States
(12) Patent Application Publication
(10) Pub. No.: US 2011/0222314 A1
(43) Pub. Date: Sep. 15, 2011

(54) POWER SUPPLY WITH REDUCED POWER CONSUMPTION

(75) Inventors: KUO-CHI LIU, HSINCHU CITY (TW); NAN-MING CHEN, TAIPEI CITY (TW); YONG-CHIN LEE, TAINAN CITY (TW); MING-HSUEH LEE, KAOHSIUNG CITY (TW)

(73) Assignee: RICHTEK TECHNOLOGY CORP., HSINCHU (TW)

(21) Appl. No.: 13/043,790

(22) Filed: Mar. 9, 2011

(30) Foreign Application Priority Data
Mar. 12, 2010 (TW) 099107277

(51) Int. Cl. H02M 3/24

(52) U.S. Cl. 363/15

(57) ABSTRACT

A power supply includes an isolated power converter and a DC/DC converter. The isolated power converter includes a primary winding connected to a primary power stage, a secondary winding to generate a first output voltage, and an auxiliary winding at the primary side to generate a voltage signal proportional to the first output voltage to stabilize the first output voltage. The DC/DC converter converts the first output voltage into a second output voltage for supplying for a load.

### FIELD OF THE INVENTION

The present invention is related generally to a power supply and, more particularly, to a power supply with reduced power consumption.

### BACKGROUND OF THE INVENTION

FIG. 1 is a diagram showing a conventional AC/DC power supply for LED load application. The AC input voltage is typically 110V or 220V, and there have been power supplies designed to receive a wide range input voltage between 90V and 264V. The AC input voltage is converted by an AC/DC rectifier 10 into a DC voltage Vin including ripples thereof, and then a DC/DC converter 12 converts the DC voltage Vin into a regulated output voltage Vout for each LED load 14. For maintaining a stable output voltage Vout and for meeting the wide range input voltage Vin, the DC/DC converter 12 has to have a limited duty cycle in its normal operation, and therefore its efficiency for power conversion is limited. The DC/DC converter 12 supplies the output voltage Vout to the LED loads 14 in a distributed manner. As different types of LEDs have different forward bias voltages, a simple and extensively used solution for various types of LEDs is to adopt a relatively high and constant output voltage Vout, for example 5V. However, doing so can cause relatively large power consumption if the LED load 14 has a lower forward bias voltage.

FIG. 2 is a schematic diagram of a conventional isolated power supply, in which a transformer has its primary side connected to a primary power stage 16, and has its secondary side connected to a rectifier and filter 18. For producing a constant output voltage Vout, a feedback control circuit 20 is provided to detect the output voltage Vout, and then the obtained output information is transmitted through an isolated circuit 22 to a switching control circuit 24 at the primary side, in order to adjust the duty cycle of the primary power stage 16, and in turn maintain the output voltage Vout stable, thereby forming a close-loop DC/DC converter. The isolated circuit 22 is typically a photocoupler or a transformer.

U.S. Pat. No. 5,894,412 proposes an open-loop isolated power supply with a constant duty cycle, whose output is connected to multiple DC/DC converters for providing regulated voltages for respective loads to optimize the working efficiency. While this power supply system saves the isolated circuit, the open-loop isolated power supply nevertheless has its output voltage varying substantially with the load and the input voltage, and thus may have overvoltage or undervoltage issues.

Therefore, it is desired a power supply with reduced power consumption that can provide a stable output voltage.

### SUMMARY OF THE INVENTION

An objective of the present invention is to provide a less power consumption power supply capable of generating a stable output voltage.

According to the present invention, a power supply includes an isolated power converter and a DC/DC converter. The isolated power converter includes a primary winding connected to a primary power stage, a secondary winding to generate a first output voltage, and an auxiliary winding in the primary side to generate a voltage signal proportional to the first output voltage to stabilize the first output voltage. The DC/DC converter converts the first output voltage into a second output voltage to supply to a load.

### BRIEF DESCRIPTION OF THE DRAWINGS

These and other objectives, features and advantages of the present invention will become apparent to those skilled in the art upon consideration of the following description of the preferred embodiments of the present invention taken in conjunction with the accompanying drawings, in which:

FIG. 1 is a diagram showing a conventional AC/DC power supply for LED load application;

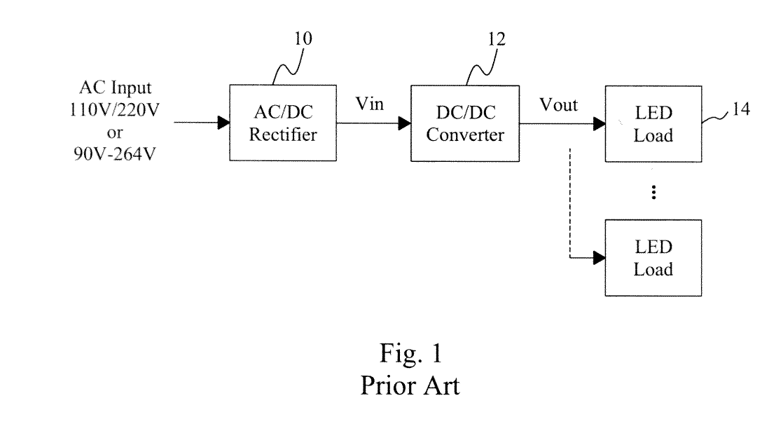

FIG. 2 is a schematic diagram of a conventional isolated power supply;

FIG. 3 is a first embodiment according to the present invention;

FIG. 4 is a second embodiment according to the present invention;

FIG. 5 is an embodiment using a flyback power converter in the power supply of FIG. 3; and

FIG. 6 is a diagram showing the power supply of FIG. 4 for LED load application.

### DETAILED DESCRIPTION OF THE INVENTION

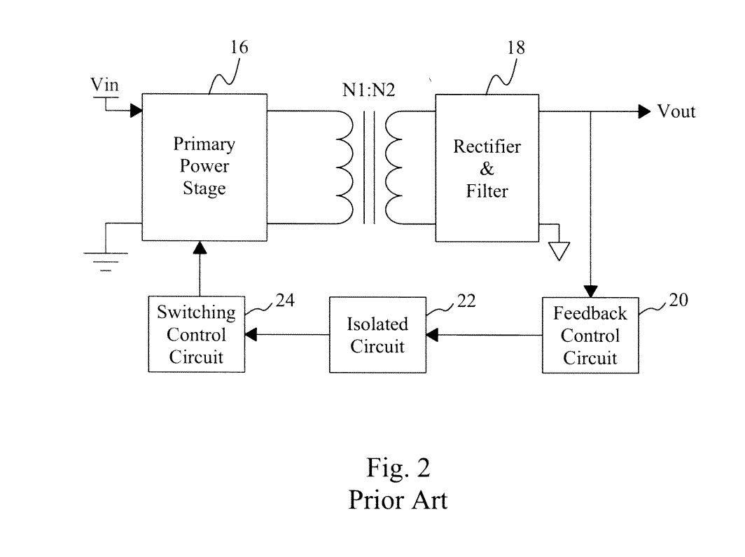

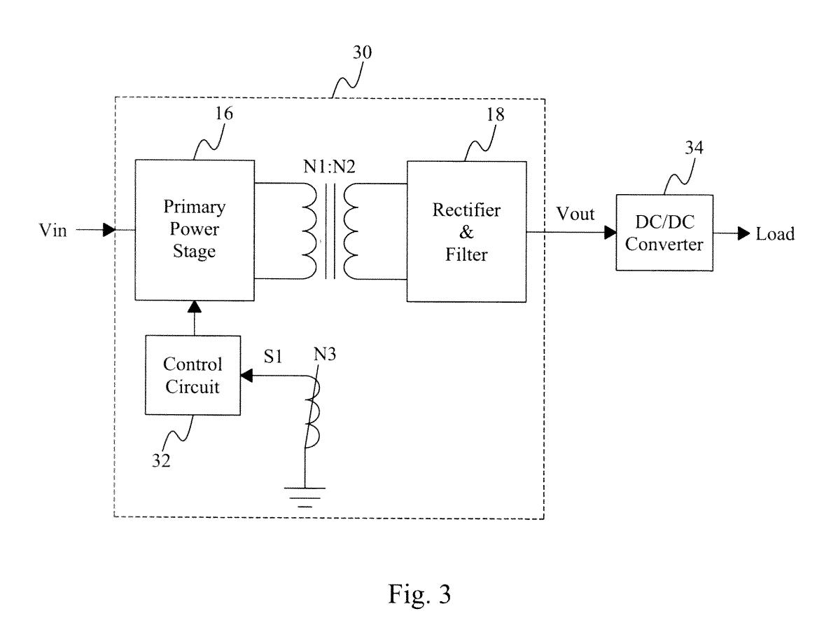

FIG. 3 is a first embodiment according to the present invention. This power supply includes an isolated power converter 30 and a DC/DC converter 34. In addition to a primary winding N1 connected to a primary power stage 16 and a secondary winding N2 connected to a rectifier and filter 18, the isolated power converter 30 further includes an auxiliary winding N3 at the primary side. This auxiliary winding N3 generates a voltage signal S1, and a control circuit 32 multiplies the voltage signal S1 by the turn ratio between the secondary winding N2 and the auxiliary winding N3, namely N2:N3. Thereby, the value of the output voltage Vout can be learned at the primary side without the use of the isolated circuit 22 as shown in FIG. 2. Therefore, the control circuit 32 is enabled to control the primary power stage 16 according to the voltage signal S1 for adjusting the power converter, thereby always providing a stable output voltage Vout to the DC/DC converter 34, and also providing overvoltage/undervoltage protection. At last, according to the characteristics of the load, the DC/DC converter 34 optimally converts the output voltage Vout to reduce power consumption on the load side. The isolated power converter 30 may be structurally of a full-bridge based circuit, a half-bridge based circuit, a push-pull based circuit, a forward based circuit, a flyback based circuit, a buck based circuit or a buck-boost based circuit.

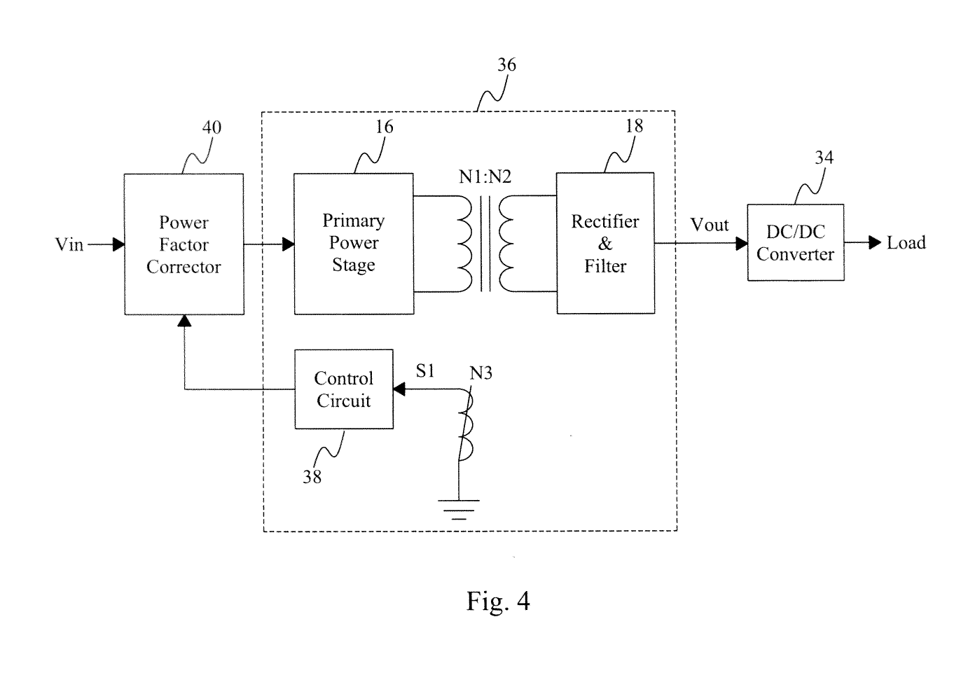

FIG. 4 is a second embodiment according to the present invention, in which a power supply includes an isolated power converter 36, a DC/DC converter 34, and a power-factor corrector (PFC) 40. In the isolated power converter 36, the primary power stage 16 is switched with a constant duty cycle, and a control circuit 38, after obtaining the voltage signal S1 provided by the auxiliary winding N3, sends a signal to the power-factor corrector 40 for adjusting the input voltage of the isolated power converter 36 so as to maintain a stable output voltage Vout. The power-factor corrector 40 serves to not only improve power factor, but also receive a wide range input voltage Vin and convert it into a higher DC voltage for the next stage power converter. The power-factor corrector 40 may be structurally of a typical boost based circuit.

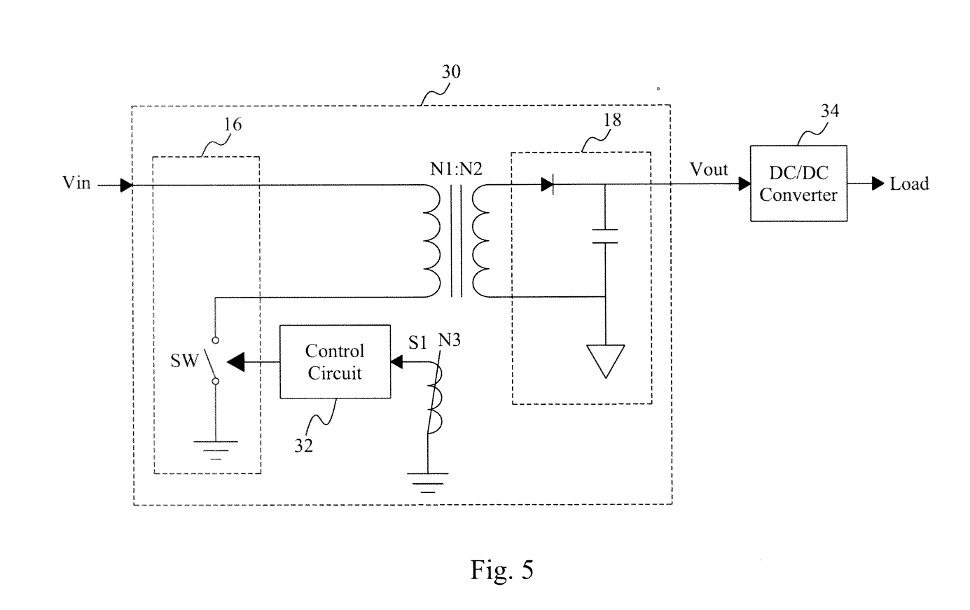

FIG. 5 is an embodiment using a flyback power converter in the power supply of FIG. 3, in which the voltage signal S1 generated by the auxiliary winding N3 and the output voltage Vout generated by the secondary winding N2 have the ratio N3:N2, and thus the control circuit 32 can stabilize the output voltage Vout by properly adjusting the duty cycle of the power switch SW at the primary side according to the voltage signal S1.

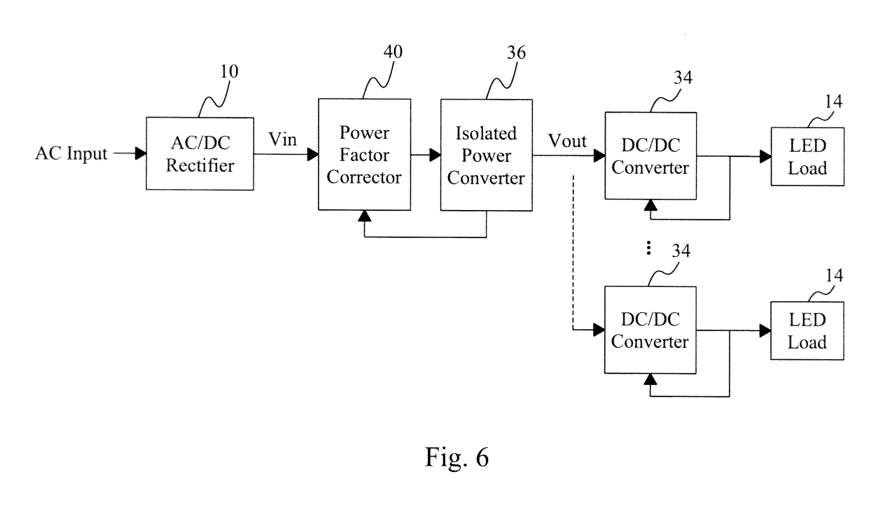

FIG. 6 is a diagram showing the power supply of FIG. 4 for LED load application, in which the AC input voltage is converted to a DC voltage Vin by the AC/DC rectifier 10, the power-factor corrector 40 steps up the DC voltage Vin for the isolated power converter 36 having the auxiliary winding, and the output Vout of the isolated power converter 36 is coupled to the distributed DC/DC converters 34 that adjust their respective output voltages and currents to meet the needs of the LEDs according to the characteristics of their respective LED loads 14. The isolated power converter 36 has its output voltage Vout being monitored and fed back to the power-factor corrector 40, and has overvoltage/undervoltage protection. By properly stepping up the output voltage Vout of the isolated power converter 36 and supplying power to the DC/DC converters 34 in a distributed manner, the current on the circuit between the isolated power converter 36 and the DC/DC converters 34 can be reduced, thereby reducing the copper loss in the circuit. The output voltages of the DC/DC converters 34 are automatically adjusted according to the characteristics of the respective LED loads 14, thereby reducing the power consumption on the load side and improving the efficiency. This embodiment thus significantly reduces the power loss and enhances the overall efficiency of the system.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A power supply comprising:
an isolated power converter including:
a primary winding connected to a primary power stage;
a secondary winding generating a first output voltage; and
an auxiliary winding at the primary side, generating a voltage signal proportional to the first output voltage in order to stabilize the first output voltage; and
a DC/DC converter connected to the isolated power converter, converting the first output voltage into a second output voltage for a load.

2. The power supply of claim 1, wherein the isolated power converter comprises a control circuit operative to control the primary power stage according to the voltage signal.

3. The power supply of claim 1, further comprising a power-factor corrector connected to the isolated power converter, providing a third output voltage supplied to the isolated power converter.

4. The power supply of claim 3, wherein the isolated power converter comprises a control circuit operative to control the power-factor corrector according to the voltage signal, so as to adjust the third output voltage and thereby stabilize the first output voltage.

5. The power supply of claim 4, wherein the primary power stage is operated with a constant duty cycle.

6. The power supply of claim 3, wherein the power-factor corrector comprises a boost based circuit.

7. The power supply of claim 1, wherein the isolated power converter comprises a full-bridge based circuit, a half-bridge based circuit, a push-pull based circuit, a forward based circuit, a flyback based circuit, a buck based circuit or a buck-boost based circuit.

8. The power supply of claim 1, wherein the DC/DC converter comprises a control circuit operative to detect the load and adjust the second output voltage accordingly.
